(19) United States
(12) Patent Application Publication
(10) Pub. No.: US 2015/0346747 A1
(43) Pub. Date: Dec. 3, 2015

(54) OFF SIGNAL GENERATOR AND POWER CONVETER INCLUDING THE SAME

(71) Applicant: SAMSUNG ELECTRO-MECHANICS CO., LTD., Suwon-si (KR)

(72) Inventors: Jung Eui PARK, Suwon-Si (KR); Min Young AHN, Suwon-Si (KR); Dae Hoon HAN, Namyangju-si (KR); Seung Kon KONG, Suwon-Si (KR); Hyun Ku KANG, Seoul (KR)

(73) Assignee: SAMSUNG ELECTRO-MECHANICS CO., LTD., Suwon-si (KR)

(21) Appl. No.: 14/550,828

(22) Filed: Nov. 21, 2014

(30) Foreign Application Priority Data
Jun. 3, 2014 (KR) 10-2014-0067704

(51) Int. Cl. G05F 1/56

(52) U.S. Cl. CPC G05F 1/56

(57) ABSTRACT

An off signal generator may be capable of supplying a uniform current. The off signal generator may comprise an off signal generation unit outputting an off signal in response to a first signal and blocking the off signal from being output in response to a second signal, and a signal control unit generating the second signal at a preset time interval and transferring the generated second signal to the off signal generation unit.

### CROSS REFERENCE(S) TO RELATED APPLICATIONS

This application claims the benefit under 35 U.S.C. Section 119 of Korean Patent Application Serial No. 10-2014-0067704, entitled “Off Signal Generator And Power Converter Including The Same” filed on Jun. 3, 2014, which is hereby incorporated by reference in its entirety into this application.

### BACKGROUND

1. Technical Field

Embodiments of the present invention generally relates to an off signal generator and a power converter including the same.

2. Description of the Related Art

Generally, switch mode power apparatuses such as a buck converter, a flyback converter, and the like have been widely used in electronics. The switch mode power apparatuses may control a flow of current to generate a voltage. In particular, the switch mode power apparatuses supplying power to an LED, and the like may make a constant current flow in the LED and thus there may be a need to make brightness of the LED uniform. Therefore, a need may exist for a power converter which may make a uniform current flow.

### SUMMARY

Some embodiments of the present invention may provide an off signal generator capable of supplying a uniform current and a power converter including the same.

According to some exemplary embodiments of the present invention, there may be provided an off signal generator including an off signal generation unit outputting an off signal by receiving a first signal and blocking the off signal from being output by receiving a second signal, and a signal control unit generating the second signal at a preset time interval and transferring the generated second signal to the off signal generation unit.

According to some exemplary embodiments of the present invention, there may be provided a power converter including a controller which may include an on signal generator generating an on signal turning on the switch and an off signal generator turning off the switch. The off signal generator may comprise an off signal generation unit outputting an off signal by receiving a first signal and blocking the off signal from being output by receiving a second signal, and a signal control unit generating the second signal at a preset time interval and transferring the generated second signal to the off signal generation unit.

According to some exemplary embodiments of the present invention, there may be provided a current control method for controlling a flow of current by controlling a switching operation of a switch using an on signal and an off signal. The current control method may comprise outputting the on signal, outputting the off signal by receiving a first signal, and blocking the off signal from being output by receiving a second signal and generating the second signal at a preset time interval.

### BRIEF DESCRIPTION OF THE DRAWINGS

FIG. 1 is a circuit diagram illustrating an off signal generator according to a first exemplary embodiment of the present invention.

FIG. 2 is a timing diagram illustrating an operation of the off signal generator illustrated in FIG. 1.

FIG. 3 is a circuit diagram illustrating an off signal generator according to a second exemplary embodiment of the present invention.

FIG. 4 is a timing diagram illustrating an operation of the off signal generator illustrated in FIG. 3.

FIG. 5 is a structural diagram illustrating a structure of a power converter in which an off signal generator according to an exemplary embodiment of the present invention is adopted.

FIG. 6 is a flow chart illustrating a method for generating an off signal according to an exemplary embodiment of the present invention.

### DESCRIPTION OF THE PREFERRED EMBODIMENTS

Matters of an action effect and a technical configuration of a converter and an off signal generator and a power converter including the same according to an exemplary embodiment of the present invention to achieve the above object will be clearly obvious by the following detailed description with reference to the drawings which illustrate exemplary embodiments of the present invention.

Further, when it is determined that the detailed description of the known art related to the present invention may obscure the gist of the present invention, the detailed description thereof will be omitted. In the description, the terms first, second, and so on are used to distinguish one element from another element, and the elements are not defined by the above terms.

Embodiments of the present invention will be described in detail with reference to the accompanying drawings. These embodiments will be described in detail for those skilled in the art in order to practice the present invention. It should be appreciated that various embodiments of the present invention are different but do not have to be exclusive. For example, specific shapes, configurations, and characteristics described in an embodiment of the present invention may be implemented in another embodiment without departing from the spirit and the scope of the present invention. In addition, it should be understood that position and arrangement of individual components in each disclosed embodiment may be changed without departing from the spirit and the scope of the present invention. Therefore, a detailed description described below should not be construed as being restrictive. In addition, the scope of the present invention is defined only by the accompanying claims and their equivalents if appropriate. Similar reference numerals will be used to describe the same or similar functions throughout the accompanying drawings.

Hereinafter, exemplary embodiments of the present invention will be described in detail with reference to the accompanying drawings so that those skilled in the art may easily practice the present invention.

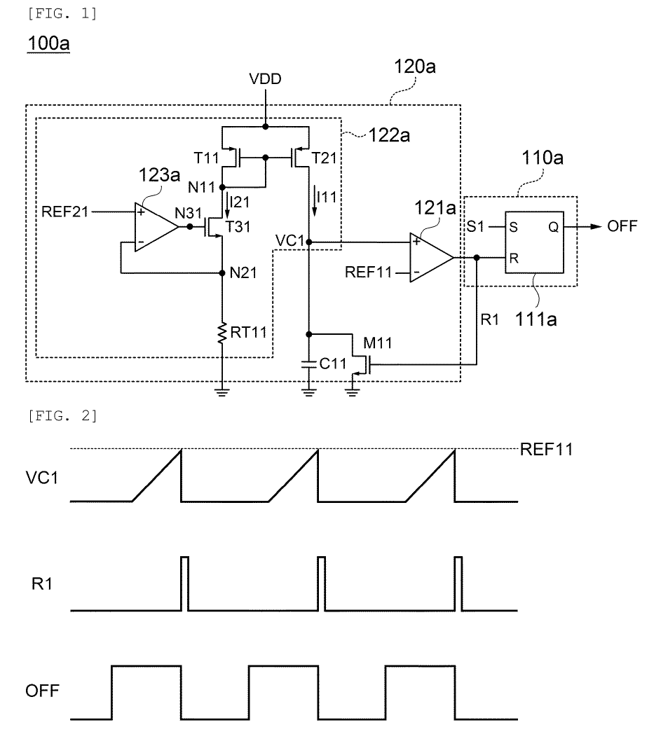

FIG. 1 is a circuit diagram illustrating an off signal generator according to a first exemplary embodiment of the present invention.

Referring to FIG. 1, an off signal generator 100a may include an off signal generation unit 110a receiving a first signal S1 to output an off signal OFF and receiving a second signal R1 to block the off signal OFF from being output, and a signal control unit 120a generating the second signal R1 at a preset time interval and transferring the generated second signal R1 to the off signal generation unit 110a. For example, but not limited to, the preset time interval may be a constant time interval and may be changed according to conditions.

The off signal generation unit 110a may receive the first signal S1 to output the off signal OFF and may receive the second signal R1 to block the off signal. The off signal generation unit 110a may include, for instance, but not limited to, an RS flip flop 111a, in which the first signal S1 may be input to a first stage S of the RS flip flop 111a and the second signal R1 may be input to a second stage R of the RS flip flop 111a. When the first signal S1 is input to the first stage S, the off signal OFF may be output from the output stage Q, and when the second signal R1 is input to the second stage R, the off signal OFF may not be output from the output stage Q.

The signal control unit 120a may generate the second signal R1 at the preset time interval and transfer the generated second signal R1 to the off signal generation unit 110a. The signal control unit 120a may include a capacitor C11 charged with a first current I11 to output a first voltage VC1, a first comparator 121a outputting the second signal R1 when the first voltage VC1 reaches a first reference voltage REF11, and a switch M11 receiving the second signal R1 to discharge the capacitor C11. The first comparator 121a may compare the first voltage VC1 with the first reference voltage REF11 and output the second signal R1 when the first voltage VC1 reaches the first reference voltage REF11. The first comparator 121a may have a positive (+) input terminal receiving the first voltage VC1 and a negative (−) input terminal receiving the first reference voltage REF11. The positive (+) terminal of the first comparator 121a is connected to the capacitor C11 which is charged with the first current I11 to apply the first voltage VC1 to the positive (+) terminal of the first comparator 121a. When the capacitor C11 is continuously charged with the first current I11, the first voltage VC1 may be increased with the passage of time. Further, when the switch M11 connected to the capacitor C11 in parallel is turned on, the capacitor C11 may be discharged. Further, the preset time interval may correspond to a time interval at which the first voltage VC1 reaches the first reference voltage REF11.

Further, the signal control unit 120a may drive a second current I21 to make the first current I11 flow. The signal control unit 120a may include a mirror unit 122a. When the second current I21 is driven, the first current I11 may flow by the mirroring to make the first current I11 flow in the capacitor C11. The mirror unit 122a may include a first transistor T11 of which the first electrode is connected to a first power source VDD, the second electrode is connected to a first node N11, and the gate electrode is connected to the first node N11, a second transistor T21 of which the first electrode is connected to the first power source VDD, the second electrode is connected to one terminal of the capacitor C11 and the positive (+) input terminal of the first comparator 121a, and the gate electrode is connected to the gate electrode of the first transistor T11, a third transistor T31 of which the first electrode is connected to the first node N11, the second electrode is connected to a second node N21, and the gate electrode is connected to a third node N31, and a second comparator 123a of which the positive (+) input terminal receives the second reference voltage REF21, the negative (−) input terminal is connected to the second node N21, and the output terminal is connected to the third node N31. Further, the second node N21 may be connected to a ground through a resistor RT11.

FIG. 2 is a timing diagram illustrating an operation of the off signal generator illustrated in FIG. 1.

Referring to FIG. 2, first, the first current I11 may be driven in the mirror unit 122a. Since the first transistor T11 may be diode-connected to the first electrode and the gate electrode in the mirror unit 122a, a current may flow from one terminal of the first transistor T11 to the other terminal thereof. In this configuration, when a voltage of the second node N21 is lower than a second reference voltage REF21, the second comparator 123a may increase the amount of current flowing in the resistor RT11 through the third transistor T31, and when the voltage of the second node N21 is higher than the second reference voltage REF21, the second comparator 123a may reduce the amount of current flowing in the resistor RT11 through the third transistor T31. Therefore, the second current I21 having a predetermined magnitude may flow in the ground direction from the first power source VDD by the second comparator 123a. Further, the first transistor T11 and the second transistor T21 may be mirrored. For example, the gate electrode of the second transistor T21 may be connected to the gate electrode of the first transistor T11. As a result, the voltage applied to the gate electrode of the first transistor T11 may be applied to the gate electrode of the second transistor T21, and thus the first current I11 driven by the second current I21 may flow in a second electrode direction from the first electrode of the second transistor T21. In this case, a magnitude of the first current I11 driven by the second current I21 may be determined corresponding to a ratio of a channel of the second transistor T21 to a channel of the first transistor T11.

Further, when the first current I11 is driven, the capacitor C11 may be charged with the first current I11 and thus the capacitor C11 may output the first voltage VC1. In this case, the first voltage VC1 may be increased with the passage of time. In this case, when the magnitude of the first voltage VC1 reaches the magnitude of the first reference voltage REF11, the first comparator 121a may output the second signal R1. Further, since the magnitude of the first current I11, a capacitance of the capacitor C11, and the first reference voltage REF11 may be fixed, the time when the first voltage VC1 output from the capacitor C11 reaches the first reference voltage REF11 may be periodical or fixed and thus a pulse width of the off signal OFF may be constant or fixed. When the first comparator 121a output the second signal R1, the off signal generation unit 110a may block the off signal OFF. The off signal generation unit 110a may block the off signal OFF until it again receives the first signal S1.

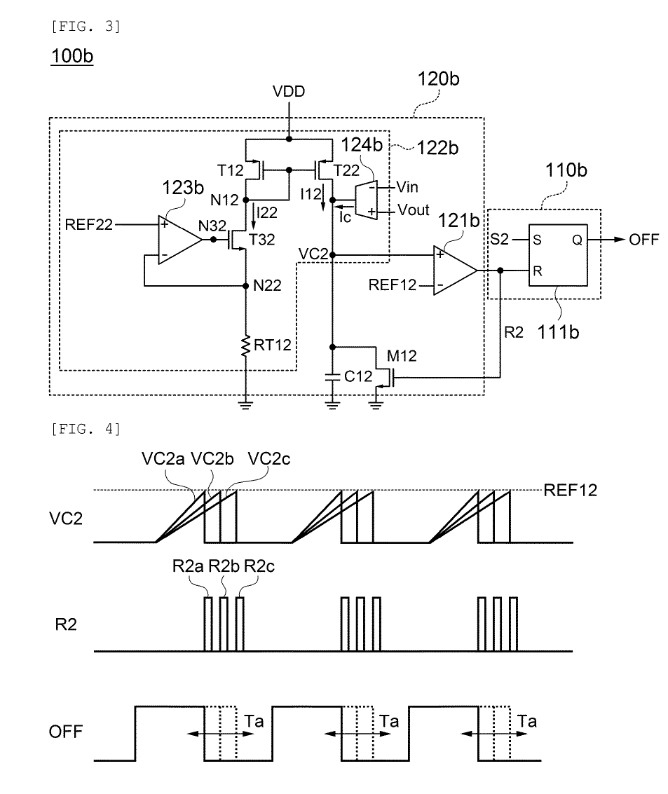

FIG. 3 is the circuit diagram illustrating an off signal generator according to a second exemplary embodiment of the present invention.

Referring to FIG. 3, a configuration of the off signal generator 100b may be similar with the off signal generator 100a illustrated in FIG. 1 and therefore only different components will be described.

An off signal generator 100b may further include a compensation current source 124b which may control the preset time interval, in which the compensation current source 124b supplies a compensation current to a capacitor C12. That is, a first current I12 and a compensation current Ic may be transferred to the capacitor C12 by the compensation current source 124b. A magnitude of the compensation current Ic may be controlled depending on a ratio of an output voltage Vout to an input voltage Vin. The compensation current source 124b may be the same current source as a transconductance amplifier. The transconductance amplifier may generate the compensation current Ic by a voltage difference between a positive (+) input terminal and a negative (−) input terminal. Further, the transconductance amplifier may have the positive (+) input terminal connected to the output voltage Vout and the negative (−) input terminal connected to the input voltage Vin. Further, the input voltage Vin and the output voltage Vout may each be an input terminal voltage and an output terminal voltage of the electronic which is adopted in the off signal generator 100b. However, the voltages input to the positive (+) input terminal and the negative (−) input terminal, respectively, are not limited to the input terminal voltage and the output terminal voltage and therefore may be a voltage received from different voltage sources.

FIG. 4 is a timing diagram illustrating an operation of the off signal generator illustrated in FIG. 3.

Referring to FIG. 4, first, the first current I12 may be driven in a mirror unit 122b. Since a first transistor T12 may be diode-connected to the first electrode and the gate electrode in the mirror unit 122b, a second current I22 may flow from the first electrode of the first transistor T12 to the second electrode thereof. In this configuration, when a voltage of the second node N22 is lower than a second reference voltage REF22, the second comparator 123b may increase the amount of current flowing in a resistor RT12 through a third transistor T32 and when the voltage of the second node N22 is higher than the second reference voltage REF22, the second comparator 123b may reduce the amount of current flowing in the resistor RT12 through the third transistor T32. Therefore, the second current I22 having a predetermined magnitude may flow in the ground direction from the first power source VDD by the second comparator 123b. Further, the first transistor T12 and a second transistor T22 may be mirrored. For instance, a gate electrode of the second transistor T22 may be connected to the gate electrode of the first transistor T12. As a result, the voltage applied to the gate electrode of the first transistor T12 may be applied to the gate electrode of the second transistor T22, and thus the first current I12 driven by the second current I22 may flow in a second electrode direction from the first electrode of the second transistor T22. In this case, a magnitude of the first current I12 driven by the second current I22 may be determined corresponding to a ratio of a channel of the second transistor T22 to a channel of the first transistor T12.

Further, when the first current I12 is driven, the capacitor C12 may be charged with the first current I12. Further, since the compensation current source 124b is connected to the capacitor C12 to charge the capacitor C12, the first voltage VC2 charged in the capacitor C12 may be output by the first current I12 and the compensation current Ic. In this case, the magnitude of the compensation current Ic may be controlled depending on the magnitude of the input voltage Vin and/or the output voltage Vout. When the magnitude of the input voltage Vin is equal to that of the output voltage Vout, the compensation current Ic does not flow, and when the magnitude of the output voltage Vout is smaller than that of the input voltage Vin, the compensation current Ic may flow. In this case, when the difference between the magnitude of the input voltage Vin and the magnitude of the output voltage Vout is large, the magnitude of the compensation current Ic may be larger than the case in which the difference between the magnitude of the input voltage Vin and the magnitude of the output voltage Vout is small.

When the compensation current Ic flows, the time when the magnitude of the first voltage VC2 reaches the magnitude of the first reference voltage REF12 may be shorter than the case in which the compensation current Ic does not flow. Therefore, the time when the magnitude of the first voltage VC2 reaches the first reference voltage REF12 may be reduced by the compensation current Ic. For example, when the magnitude of the compensation current Ic is large, a slope VC2a of the first voltage VC2 may be steep, and when the magnitude of the compensation current Ic is small, a slope VC2b of the first voltage VC2 may be gentle. Further, when there is no the compensation current Ic, a slope VC2c of the first voltage VC2 may be the gentlest.

When the magnitude of the first voltage VC2 reaches the magnitude of the first reference voltage REF12, the first comparator 121b may output a second signal R2, and the time to output the second signal R2 may be controlled by controlling the magnitude of the compensation current Ic. For instance, the second signal R2 may be one of R2a, R2b, and R2c according to the compensation current Ic. Further, the first comparator 121b may output the second signal R2 and thus the off signal generation unit 110b may block the off signal OFF responding to the second signal R2, such that the time to block the off signal OFF may be controlled by a predetermined time interval Ta.

The off signal generation unit 110b may block the off signal OFF from being output until it again receives the first signal S1. Therefore, the pulse width of the off signal OFF may be controlled.

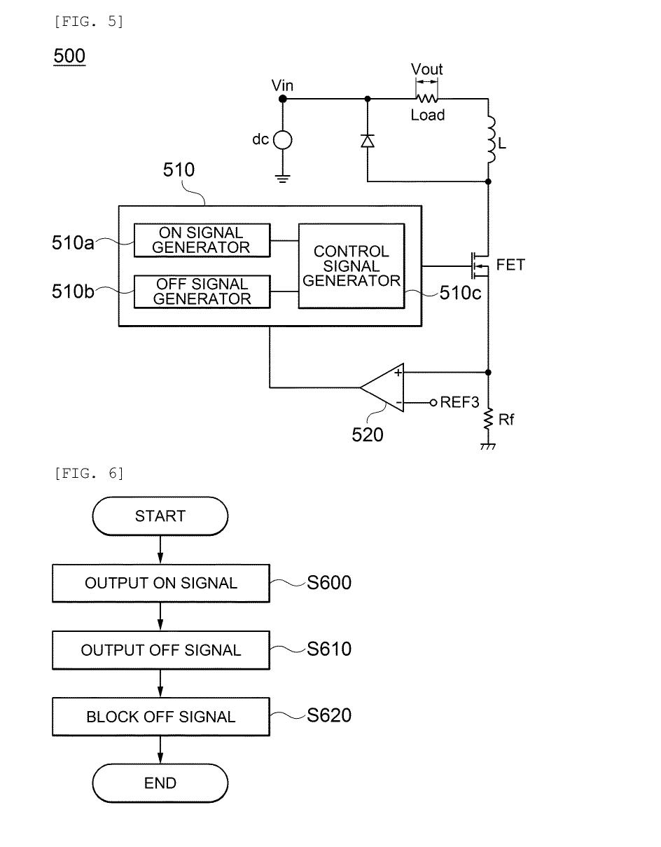

FIG. 5 is a circuit diagram illustrating a power converter in which an off signal generator according to an exemplary embodiment of the present invention is adopted.

Referring to FIG. 5, a power converter 500 may include a coil L, a switch FET connected to the coil L to control a current flowing in the coil L and control a voltage applied to a load, and a control unit 510 controlling a switching operation of the switch FET. The control unit 510 may include an on signal generator 510a generating an on signal turning on the switch FET and an off signal generator 510b generating an off signal turning off the switch FET. Further, the control unit 510 may include a control signal generator 510c which receives the on signal from the on signal generator 510a and the off signal from the off signal generator 510b to generate a control signal turning on/off the switch FET. The control signal generator may be, for instance, but not limited to, an RS flip flop and the signal output from the on signal generator 510c may be input to the first stage S of the RS flip flop and the signal output from the off signal generator 510b may be input to the second stage R of the RS flip flop. Further, the output stage Q of the RS flip flop may control the switching operation of the switch FET. Here, the power converter 500 may be a buck converter but is not limited thereto, and may be a switch mode converter such as a flyback converter, an LLC and the like.

The power converter 500 may receive the input voltage Vin from a voltage source dc to supply a current to the load which may be connected to the coil L. Here, the voltage source dc may be a direct current obtained by rectifying an alternate current. Further, the coil L is connected to the switch FET, and the magnitude of the current flowing in the coil L may be controlled according to the turn on/off operation of the switch FET. For example, the load may be an LED array in which a plurality of LEDs is connected in series. Here, there may be at least one array of LEDs which are the load. In this case, an anode voltage and a cathode voltage of the LED may each be the input voltage Vin and the output voltage Vout. Further, as represented by the following Equation 1, the control unit 510 may control a ratio of a turn off interval of the switch FET to a turn off interval thereof depending on a ratio of the output voltage Vout to the input out Vin. That is, a duty ratio of the switch FET may be controlled corresponding to the ratio of the output voltage Vout to the input voltage Vin.

$$duty = \frac{Vout}{Vin} \qquad [ Equation 1 ]$$

In the above Equation 1, the duty represents the ratio of the turn off interval of the switch FET to the turn on interval thereof, the Vout represents the cathode voltage of the LED, and the Vin represents the anode voltage of the LED.

In this case, when the off signal generator 510b of the control unit 510 adopts the off signal generator 100a illustrated in FIG. 1, since the length of the turn off interval may not be controlled, when the turn on interval is short, a frequency to turn on/off the switch FET may be short. However, when the off signal generator 510b of the control unit 510 adopts the off signal generator 100b illustrated in FIG. 3, since the length of the turn off interval may be controlled. For instance, when the turn on interval is short, the turn off time may be increased, and when the turn on interval is long, the turn off time may be reduced, such that the frequency of the control signal to turn on/off the switch FET may be constantly maintained.

The input voltage and the output voltage of the power converter 500 may be altered depending on electronics in which the power converter 500 is adopted. In particular, the magnitude of the output voltage Vout may be altered depending on a kind of loads which is connected to the power converter 500.

Further, the control unit 510 may control the turn on time of the switch FET corresponding to a voltage applied to a resistor Rf to make a current flowing in the load uniform. To this end, the control unit 510 may control the on time which is the period at which the switch FET is turned on corresponding to the output signal by allowing the third comparator 520 to compare the voltage applied to the resistor Rf which is the voltage corresponding to the current flowing in the load with the third reference voltage REF3.

FIG. 6 is a flow chart illustrating a method for generating an off signal according to an exemplary embodiment of the present invention.

Referring to FIG. 6, a current control method for controlling a flow of current by controlling a switching operation of a switch using an on signal and an off signal may include steps of outputting the on signal (S600), outputting the off signal responding to or, by receiving, a first signal (S610), and blocking the off signal from being output, responding to, by receiving, a second signal and generating the second signal at a preset time interval (S620).

In the step of outputting of the on signal (S600), the switch may be turned on by the on signal and thus the current may flow in the load. For instance, when the switch mode converter such as the buck converter and the flyback converter is adopted, the switch is connected to the coil and the current may flow in the coil by the turn on operation of the switch. Further, in the step of outputting of the off signal (S610), the switch may be turned off by the off signal to block the current. Therefore, the amount of current flowing in the coil may be controlled by the current flowing in the switch. A method for transferring an off signal to a switch may output the off signal corresponding to the received first signal. Further, in the step of blocking the off signal from being output responding to a second signal and generating the second signal at the preset time interval (S620), the off signal may be blocked by the received second signal after the predetermined time elapses. In this case, when the off signal is transferred at a predetermined time, the off time of the switch may be fixed or periodical. In the case of controlling the duty ratio, when the on time of the switch is changed, the duty ratio may be changed. However, since the off time may be fixed, when the turn on time of the switch is long, the time of one period at which the switch is turned on/off may be long, and when the turn off time of the switch is short, the time of one period at which the switch is turned on/off may be short. That is, the frequency of the signal to turn on/off the switch may be changed.

On the other hand, when the off time of the switch may be controlled by controlling the time to transfer the off signal, the off time of the switch may be changed depending on the on time of the switch. For instance, when the on time is long, the off time of the switch may be short and when the on time is short, the off time of the switch may be long, such that the time of one period to turn on/off the switch may be constant.

The functions of various elements illustrated in the drawings of embodiments of the present invention may be provided by using hardware which may be associated with proper software to execute the software and dedicated hardware. When being provided by a processor, the function may be provided by a single dedicated processor, a single sharing processor, or a plurality of individual processors which may be partially shared.

In claims of the present specification, elements expressed as a unit for performing specific functions include any method of performing a specific function and these elements may include a combination of circuit elements performing the specific function or any type of software including a firmware, a microcode, and the like which are coupled with circuits suitable to perform software for performing the specific functions.

In the present specification, ‘one embodiment’ of principles of the present invention and the designation of various changes of the expression mean that specific features, structures, characteristics, and the like, associated with the embodiment are included in at least one embodiment of the principle of the present invention Therefore, the expression ‘one embodiment’ and any other modification examples disclosed throughout the present specification do not necessarily mean the same embodiment.

The designation of various changes of these expressions such as ‘connected’ or ‘connecting’, and the like in the present specification means that one element may be connected directly to or coupled directly to another element or be connected indirectly to or coupled indirectly to another element, having the other element intervening therebetween. Unless explicitly described to the contrary, a singular form includes a plural form in the present specification. In addition, components, steps, operations, and elements mentioned in the present specification do not exclude the existence or addition of one or more other components, steps, operations, elements and apparatuses.

According to some exemplary embodiments of the present invention, the off signal generator and the power converter including the same may make the amount of current flowing through the off signal uniform.

What is claimed is:

1. An off signal generator, comprising:
an off signal generation unit outputting an off signal in response to a first signal and blocking the off signal from being output in response to a second signal; and
a signal control unit generating the second signal at a preset time interval and transferring the generated second signal to the off signal generation unit.

2. The off signal generator according to claim 1, wherein the signal control unit includes:
a capacitor charged with a first current to output a first voltage;
a first comparator outputting the second signal when the first voltage reaches a first reference voltage; and
a transistor receiving the second signal to discharge the capacitor.

3. The off signal generator according to claim 2, wherein the preset time interval corresponds to a time interval at which the first voltage reaches the first reference voltage.

4. The off signal generator according to claim 3, wherein the signal control unit drives a second current to make a flow of the first current.

5. The off signal generator according to claim 3, further comprising:
a compensation current source configured to control the preset time interval and to supply a compensation current to the capacitor.

6. The off signal generator according to claim 5, wherein the compensation current source receives an input voltage and an output voltage and controls a magnitude of the compensation current corresponding to a magnitude of the input voltage and the output voltage.

7. A power converter, comprising:
a coil;
a switch connected to the coil to control a current flowing in the coil and control a voltage applied to a load; and
a control unit controlling a switching operation of the switch, the control unit comprising an on signal generator generating an on signal turning on the switch and an off signal generator turning off the switch,
wherein the off signal generator includes:
an off signal generation unit outputting an off signal in response to a first signal, and blocking the off signal from being output in response to a second signal; and
a signal control unit generating the second signal at a preset time interval and transferring the generated second signal to the off signal generation unit.

8. The power converter according to claim 7, wherein the signal control unit includes:
a capacitor charged with a first current to output a first voltage;
a first comparator outputting the second signal when the first voltage reaches a first reference voltage; and
a transistor receiving the second signal to discharge the capacitor.

9. The power converter according to claim 8, wherein the preset time interval corresponds to a time interval at which the first voltage reaches the first reference voltage.

10. The power converter according to claim 9, wherein the signal control unit drives a second current to make the first current flow.

11. The power converter according to claim 9, wherein the off signal generator further includes a compensation current source configured to control the preset time interval and to supply a compensation current to the capacitor.

12. The power converter according to claim 11, wherein the compensation current source receives an input voltage and an output voltage and controls a magnitude of the compensation current corresponding to a magnitude of the input voltage and the output voltage.

13. The power converter according to claim 12, wherein the input voltage corresponds to an input terminal voltage of the load and the output voltage corresponds to a voltage generated by a current flowing in the load.

14. The power converter according to claim 11, wherein the control unit further includes a control signal generator configured to receive the on signal from the on signal generator and receive the off signal from the off signal generator to output a control signal controlling a turn on/off of the switch.

15. The power converter according to claim 14, wherein the control signal generator controls an interval between the on signal and the off signal according to a ratio of an output voltage to an input voltage and constantly maintains a frequency of the control signal.

16. A method for controlling a flow of current by controlling a switching operation of a switch using an on signal and an off signal, the method comprising:
outputting the on signal;
outputting the off signal in response to a first signal; and
blocking the off signal from being output in response to a second signal and generating the second signal at a preset time interval.

17. The method according to claim 16, wherein the preset time interval corresponds to a time interval at which a first voltage reaches a first reference voltage.

18. The method according to claim 17, further comprising:
generating the first voltage by a first current; and
when the first voltage reaches the first reference voltage, generating the second signal to block the off signal.

19. The method according to claim 18, further comprising discharging the first voltage by the second signal.

20. The method according to claim 17, wherein the preset time interval is controlled depending on a turn on/off ratio of the switch.

21. The method according to claim 18, further comprising generating a compensation current compensating for the first current corresponding to a turn on/off ratio of the switch.
